(19) United States
(12) Patent Application Publication
(10) Pub. No.: US 2017/0349151 A1
(43) Pub. Date: Dec. 7, 2017

(54) VEHICLE WASH FACILITY

(71) Applicant: Alfred Kärcher GmbH & Co. KG, Winnenden (DE)

(72) Inventors: Andreas Seibold, Kernen (DE); Felix Bensing, Stuttgart (DE); Tobias Geltz, Winnenden (DE); Bernd Haberl, Weissach im Tal (DE)

(21) Appl. No.: 15/686,455

(22) Filed: Aug. 25, 2017

Related U.S. Application Data
(63) Continuation of application No. PCT/EP2015/054019, filed on Feb. 26, 2015.

(51) Int. Cl. B60S 3/00; B60S 3/04

(52) U.S. Cl. CPC B60S 3/002; B60S 3/04

(57) ABSTRACT

The invention relates to a vehicle wash facility, including a drying apparatus for drying a motor vehicle which is held to a holding device of the vehicle wash facility and includes a nozzle support device, at least one blower and a plurality of nozzles which are arranged at a distance relative to one another at the nozzle support device and which can be supplied with drying air by the at least one blower, wherein the nozzles are flat jet nozzles, each providing a flow of air that spreads out in a fan shape.

### CROSS-REFERENCE TO RELATED APPLICATIONS

This application is a continuation of international application number PCT/EP2015/054019 filed on Feb. 26, 2015, which is incorporated herein by reference in its entirety and for all purposes.

### FIELD OF THE INVENTION

The invention relates to a vehicle wash facility, comprising a drying apparatus for drying a motor vehicle.

### BACKGROUND OF THE INVENTION

In a vehicle wash facility, a drying apparatus is used following a wash operation in order to dry the vehicle by way of a flow of air. It is known that the drying apparatus can comprise a slot-shaped nozzle that extends along the entire working length. The length of the nozzle may, for example, be approximately two metres, and its operation requires a considerable volume flow of drying air in order for an acceptable drying result to be achieved. In order to supply this volume flow, a blower of the drying apparatus must have a correspondingly large size.

It is also known that the drying apparatus can comprise a plurality of duct-shaped individual nozzles. These can be supplied with drying air by separate blowers. Examples of drying apparatuses using separate nozzles are disclosed in EP 0 700 814 B1 and in U.S. Pat. No. 4,683,668. These drying apparatuses also require a substantial use of energy in order to be able to provide the volume flow necessary for an acceptable drying result.

DE 103 33 976 A1 describes a hand-holdable drying apparatus. The drying apparatus comprises a plurality of pinpoint nozzles arranged in a row. A curtain-like drying flow is thereby to be created.

An object underlying the present invention is to provide a vehicle wash facility comprising a drying apparatus which enables an acceptable drying result to be achieved with little expenditure of energy, if possible.

### SUMMARY OF THE INVENTION

In accordance with the invention, a vehicle wash facility comprises a drying apparatus for drying a motor vehicle, the drying apparatus being held to a holding device of the vehicle wash facility and comprising a nozzle support device, at least one blower and a plurality of nozzles which are arranged at a distance relative to one another at the nozzle support device. The nozzles can be supplied with drying air by the at least one blower, wherein the nozzles are flat jet nozzles, each providing a flow of air that spreads out in a fan shape.

### BRIEF DESCRIPTION OF THE DRAWINGS

The foregoing summary and the following description may be better understood in conjunction with the drawing figures, of which:

FIG. 1 shows, in a front view, a schematic representation of vehicle wash facility in accordance with the invention, configured as a gantry-type wash facility, and a vehicle to be dried;

FIG. 2 shows the vehicle wash facility of FIG. 1 in a schematic side view, with a different vehicle to be dried;

FIG. 3 schematically shows a control system of the vehicle wash facility of FIG. 1;

FIG. 4 schematically shows, in a front view, a nozzle support device including blowers of a roof drying apparatus of the vehicle wash facility of FIG. 1;

FIG. 5 shows a nozzle support device including blowers of a roof drying apparatus in a different embodiment of the vehicle wash facility; and

FIG. 6 schematically shows air flows of two nozzles of the roof drying apparatus upon impact on a vehicle surface that is to be dried.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a vehicle wash facility comprising a drying apparatus for drying a motor vehicle, the drying apparatus being held to a holding device of the vehicle wash facility and comprising a nozzle support device, at least one blower and a plurality of nozzles which are arranged at a distance relative to one another at the nozzle support device, which nozzles can be supplied with drying air by the at least one blower, wherein the nozzles are flat jet nozzles, each providing a flow of air that spreads out in a fan shape.

In the vehicle wash facility in accordance with the invention, a drying apparatus having a plurality of nozzles is used. These nozzles are flat jet nozzles in particular. “Flat jet nozzle” as used herein is understood to mean in particular a nozzle that provides a flat air flow which spreads out in one plane or in substantially one plane. The nozzles are arranged at a distance relative to one another at the nozzle support device and provide a respective fan-shaped flat jet. The air flow exits from a respective flat jet nozzle at a predetermined or predeterminable opening angle so that as the distance from the respective nozzle increases, a greater area of the vehicle surface to be dried can be covered by the air flow. By use of a plurality of nozzles, it is thereby possible to provide, through the spatially limited air outlets at the nozzle support device, a spatially extended air flow at the place of use, namely at the vehicle surface that is to be dried. By way of the flat jets, liquid can be effectively displaced from the vehicle surface to be dried. The energy expenditure in order to provide the volume flow of drying air required for this purpose at the nozzles can, as practice shows, be reduced when compared to conventional drying apparatuses.

The drying apparatus in accordance with the present invention is, for example, a roof drying apparatus of the vehicle wash facility. A “roof drying apparatus” is considered to be a drying apparatus that is used for drying the vehicle's roof in particular. Preferably, other top portions of the motor vehicle, i.e. in particular body components such as a hood or a trunk lid or the windscreen and the rear window of the vehicle, are also dried with the roof drying apparatus.

In particular, the roof drying apparatus extends transversely to a treatment direction of the vehicle wash facility. If the vehicle wash facility is a wash gantry, then the treatment direction is meant to be a direction of movement in or opposite to the vehicle longitudinal direction. If the vehicle wash facility is a wash line, the treatment direction is directed opposite to the conveying direction of the vehicle in the wash line.

It is advantageous for the drying apparatus to comprise a lifting device via which the nozzle support device is held to the holding device in a height-adjustable manner. This makes it possible for the nozzle support device to be raised or lowered as required and to be brought to a distance from the vehicle surface to be dried at which as good a drying result as possible can be achieved.

It is advantageous for the vehicle wash facility to comprise a detection device with which the location of a vehicle surface that is to be dried of the vehicle relative to the nozzles can be detected and for a distance of the nozzles from the vehicle surface to be adjustable by way of the lifting device in such a manner that air flows of adjacent nozzles, at the vehicle surface, are adjacent to one another, or at least partially overlap one another. Depending on information or a signal of the detection device, the lifting device can be controlled in order to raise or lower the nozzle support device. The lifting device and the detection device are, for example, electrically connected to a control device of the vehicle wash facility. The distance of the nozzles from the vehicle surface is preferably adjusted such that the air flows of adjacent nozzles are adjacent to one another at the vehicle surface in order to ensure that no such areas are left between “adjacent” air flows at the vehicle surface that are not covered directly by a flow of air. Preferably, the distance is adjusted such that adjacent air flows overlap one another in an overlap region at the vehicle surface. Undried areas between adjacent nozzles can thereby be prevented with particular reliability.

Preferably, the distance of the nozzles from the vehicle surface is controlled in order to be kept constant or substantially constant, depending on the contour of the vehicle.

Provision may be made for the distance of the nozzles from the vehicle surface to be adjustable such that the air flows of adjacent nozzles overlap one another above the vehicle surface to be dried. This can be understood to mean in particular that the air flows of adjacent nozzles intersect one another above the vehicle surface in order to ensure that no area of the vehicle surface is left undried between the nozzles.

The detection device preferably allows the contour of the vehicle to be detected for determining the location of the vehicle surface to be dried. To this end, the detection device may comprise, for example, one or more light barriers with which the contour of the vehicle is measured. This can be done for example prior to or during a wash operation of the vehicle wash facility. This obviates the need for having to detect the contour of the vehicle separately before the drying operation. It is also conceivable for the contour of the vehicle to be determined on the basis of optical images of the vehicle. Alternatively or in addition, the detection device can detect the type of the motor vehicle and determine the contour of the vehicle therefrom. To detect the motor vehicle type, provision may also be made in particular for an operator to indicate the vehicle type by hand or through use of an authorization carrier, such as a chip card or the like with which the vehicle wash facility is placed into operation.

In an advantageous implementation of the vehicle wash facility in practice, it proves advantageous for the distance of the nozzles from the vehicle surface to be less than approximately 50 cm, preferably less than 30 cm and more preferably approximately 10 cm to 25 cm. In a particularly advantageous implementation, the nozzles have a distance of approximately 20 cm from the vehicle surface.

In an advantageous implementation of the vehicle wash facility in practice, it is advantageous for an opening angle of the air flow provided by the nozzles to be less than approximately 120°, preferably less than 90° and more preferably approximately 50° to 80°. For example, an opening angle of approximately 70° has proven to be particularly advantageous.

The nozzles may, for example, have an opening cross-section of approximately 80 mm² to 280 mm², preferably approximately 110 mm² to 225 mm², more preferably approximately 140 mm² to 200 mm². These values can be considered in particular as being measured in projection along an outflow axis or a centre axis of the nozzles.

The at least one blower preferably provides a volume flow of approximately 15 l/s to 50 l/s, preferably approximately 20 l/s to 40 l/s and more preferably approximately 25 l/s to 35 l/s of drying air per nozzle.

In an advantageous implementation of the vehicle wash facility in practice, it is advantageous for the distance of adjacent nozzles relative to one another to be approximately 10 cm to 30 cm, preferably approximately 15 cm to 25 cm. In a particularly advantageous implementation, the nozzle distance is, for example, approximately 18 cm to 20 cm.

In an advantageous implementation of the vehicle wash facility, the distance of the nozzles from the vehicle surface can, for example, be adjusted by way of the lifting device such that the air flows of nozzles adjacent to one another overlap at the vehicle surface in an approximately 5 cm to 10 cm wide overlap region.

The air flows of adjacent nozzles intersect one another at approximately 5 cm above the vehicle surface for example.

It is advantageous for the nozzles to be arranged in equidistantly spaced relation to one another at the nozzle support device, in particular to be held to a carrier of the nozzle support device.

Preferably, the nozzle support device comprises a carrier which is oriented transversely to a treatment direction of the vehicle wash facility and at which are arranged at least two and preferably all of the nozzles side by side in a transverse direction.

The nozzles may be held to the carrier and may for example be mounted thereto. It is also conceivable for the nozzles to be formed at the carrier. To this end, the carrier may have a conduit-like configuration and comprise openings defining a respective nozzle.

Provision may be made for two or more carriers, arranged side by side in transverse direction, to be provided, each of these having arranged thereat at least one nozzle, preferably at least two nozzles. It is conceivable for the carriers to be mechanically coupled to one another and, for example, to be capable of being raised or lowered by way of a common lifting device or to be tiltable relative to the vehicle surface by way of a common tilting device. Alternatively, it is conceivable for separate lifting devices and/or tilting devices to be provided for raising and lowering and for tilting the carriers respectively.

In order to achieve a configuration that is simple in structure, it is advantageous for the carrier to be of straight-lined configuration and/or for the nozzles to be arranged along a straight line at the carrier. In this embodiment, the nozzles are in particular oriented along a line or an axis that is oriented transversely to the treatment direction.

In a different embodiment, provision may be made for the carrier to have a convex curvature in the treatment direction and/or for the nozzles to be arranged at the carrier along an arc of convex curvature in the treatment direction. As used herein, the phrase “of convex curvature in the treatment direction” can be understood in particular to mean that the carrier or the arc defined by the nozzles has an apex leading in the treatment direction.

It has already been noted that a tilting device may be provided.

It is advantageous for the drying apparatus to comprise a tilting device for tilting the nozzle support device about a tilting axis oriented transversely to the treatment direction. By tilting the nozzle support device, the direction under which the air flows impact the vehicle surface to be dried can be varied. In particular, this allows the air flows to be oriented perpendicularly to the vehicle surface. For example, upon movement of the nozzle support device, the tilt of the nozzle support device can be adjusted as needed such that the flow of air in each case impacts the vehicle surface perpendicularly. Where the treatment direction is from front to rear, the nozzle support device is, for example, tilted at the hood and at the windscreen such that the air flows comprise a component that runs in the treatment direction. At the vehicle roof, usually oriented approximately horizontally, the air flows can exit the nozzles vertically for example. The same can apply to a trunk lid. At the rear window, the nozzle support device can be tilted such that the direction of the air flows has a component that is directed opposite to the treatment direction.

Preferably, the tilting device is in electrical communication with the above-mentioned control device of the vehicle wash facility and can, for example, be tilted depending on information or on a signal of the detection device in order to adjust the direction of the air flows for achieving as good a drying result as possible.

Overall, it is advantageous for the air flows of the nozzles to be perpendicularly orientable towards a vehicle surface to be dried whose orientation is detectable by way of a detection device. The control device can therefrom determine the orientation of the vehicle surface relative to the nozzles.

Alternatively or in addition, provision may be made for the air flows of the nozzles to be oriented such that the air flows spread in a direction which always has a component in the treatment direction. This allows, for example, for liquid to be propelled off the vehicle surface in a direction of the treatment direction.

The air flows emitted from the nozzles are preferably oriented transversely to the treatment direction.

It is advantageous for the air flows emitted from the nozzles to lie in one plane or substantially in one plane. This is in particular the case when the nozzles, as mentioned above, are arranged side by side in a straight line at the carrier.

Preferably, the nozzles are of identical configuration in order to achieve a configuration of the vehicle wash facility that is simple in structure.

Provision may be made for two or more nozzles to be in flow communication with a blower. In particular, it is conceivable for the vehicle wash facility to comprise only one blower that supplies all of the nozzles with drying air.

In a different embodiment, provision may be made for the drying apparatus to comprise a plurality of blowers, each of which has a nozzle associated therewith. Each nozzle can be supplied with drying air by a separate blower.

In an advantageous implementation of the vehicle wash facility in practice, seven nozzles may be provided for example, said nozzles being jointly arranged or formed at or held to a carrier extending in transverse direction with respect to the treatment direction. The nozzles can be spaced apart from one another at a distance of approximately 15 cm to 25 cm and preferably 18 cm to 20 cm. The opening angles of the air flows of the flat jet nozzles are approximately 70°, for example. The distance from the vehicle surface can be adjusted, preferably controlled, to approximately 20 cm for example, depending on information or a signal of the detection device. Preferably, the air flows can be oriented such that they impact the vehicle surface perpendicularly.

As has already been mentioned, the vehicle wash facility may be or comprise a gantry-type wash facility. The nozzle support device is, for example, held to lateral supports of the gantry in a manner adjustable in height and tiltable about an in particular horizontal tilting axis running transversely to the treatment direction.

Alternatively, provision may be made for the vehicle wash facility to be or to comprise a wash line.

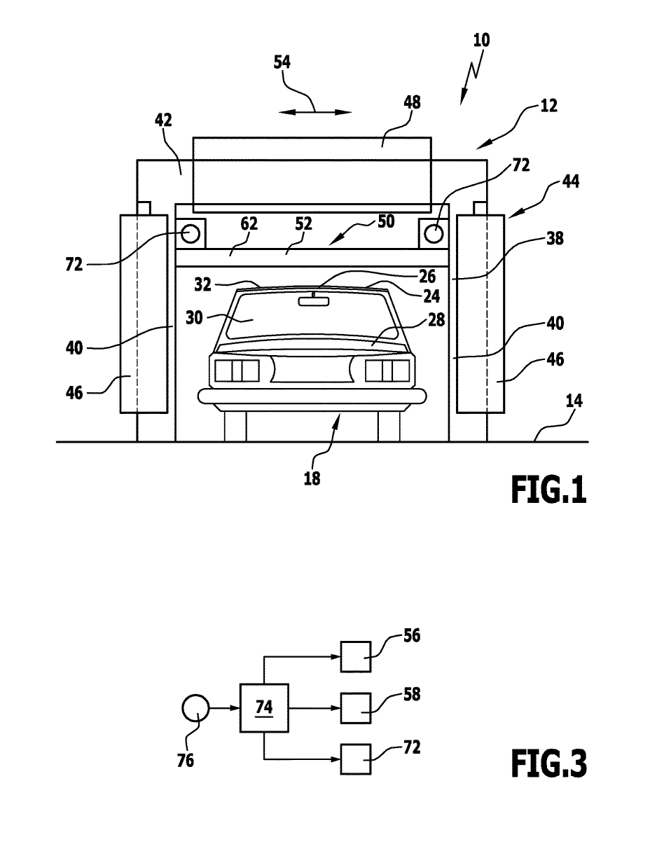

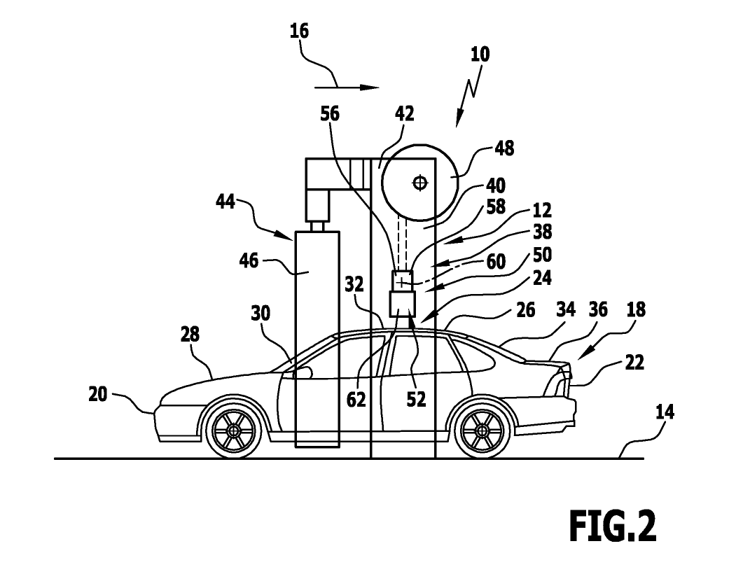

Turning now to the drawings, FIGS. 1 and 2 show in a front view and in a side view respectively an advantageous embodiment of a vehicle wash facility 10 in accordance with the invention. The vehicle wash facility 10 is configured as a gantry-type wash facility comprising a wash gantry 12 on a support surface 14. Here, the support surface 14 is to be regarded as being horizontally oriented. As used herein, positional and orientational terms such as “horizontal”, “vertical”, “above”, “below” and the like are to be taken to refer to a state of intended use of the vehicle wash facility 10 on the support surface 14 considered as being horizontal.

The wash gantry 12 can be moved along a treatment direction 16 relative to a vehicle 18 that is to be cleaned and also to be dried. Here, the treatment direction 16 extends from a front side 20 to a rear side 22 of the vehicle 18. The wash gantry 12 can also be moved in a direction opposite to the treatment direction 16.

The vehicle 18 is positioned on the support surface 14 and has a top side 24. Arranged at the top side 24 is a vehicle surface 26 that is to be dried at the end of the cleaning process. The vehicle surface 26 is formed by a hood 28, a windscreen 30, a roof 32, a rear window 34 and a trunk lid 36 of the vehicle 18.

The wash gantry 12 comprises a gantry-like holding device 38 comprising vertical supports 40 arranged in spaced relation to one another and a transverse support 42 interconnecting same. The transverse support 42 is oriented transversely relative to the treatment direction 16.

Held to the wash gantry 12 are wash tools 44 for cleaning the vehicle 18. The wash tools 44 comprise, for example, side brushes 46 at the vertical supports 40 and a roof brush 48 which is held to the transverse support 42 or to the vertical supports 40.

The vehicle 18 can be cleaned by way of the wash tools 44 in a manner known per se. Liquid, in particular water, is applied to the vehicle 18. Subsequent to the wash operation, the vehicle 18 is rinsed, also usually with water. In doing so, liquid is left on the vehicle 18, in particular on the top side 24 thereof. The liquid is removed from the top side 24 in a subsequent drying operation.

In order to dry the vehicle 18, the vehicle wash facility 10 comprises a drying apparatus 50. Here, the drying apparatus 50 is configured as a roof drying apparatus. The drying apparatus 50 is used to dry the top side 24, i.e. the top portions of the hood 28, the windscreen 30, the roof 32, the rear window 34 and the trunk lid 36.

The vehicle wash facility 10 can comprise further drying apparatuses (not shown) in order to dry the sides and/or the front side or the rear side 22 of the vehicle 18.

The drying apparatus 50 comprises a nozzle support device 52. The nozzle support device 52 is held to the vertical supports 40 of the wash gantry 12 and extends in a transverse direction 54 (transverse to the treatment direction 16). Preferably, the nozzle support device 52 is horizontally oriented.

The nozzle support device 52 is held to the vertical supports 40 in a height-adjustable manner. In order to alter the height of the nozzle support device 52 relative to the support surface 14, the drying apparatus 50 comprises a lifting device 56. The nozzle support device 52 can be lowered and raised by way of the lifting device 56. The lifting device 56 is, for example, arranged at one or both of the vertical supports 40.

The drying apparatus 50 further comprises a tilting device 58. Via the tilting device 58, the nozzle support device 52 can be tilted or pivoted relative to the vertical supports 40 about a tilting axis 60 running in the transverse direction 54. The tilting device 58 is for example arranged at the vertical support(s) 40. The tilting device 58 can form an integrated unit with the lifting device 56 or it can be formed separately therefrom.

The nozzle support device 52 comprises a carrier 62 via which the nozzle support device 52 is held to the vertical supports 40 in a height-adjustable and tiltable manner. The carrier 62 extends in the transverse direction 54 and is of straight-lined configuration. The carrier 62 is arranged above the vehicle 18 when drying.

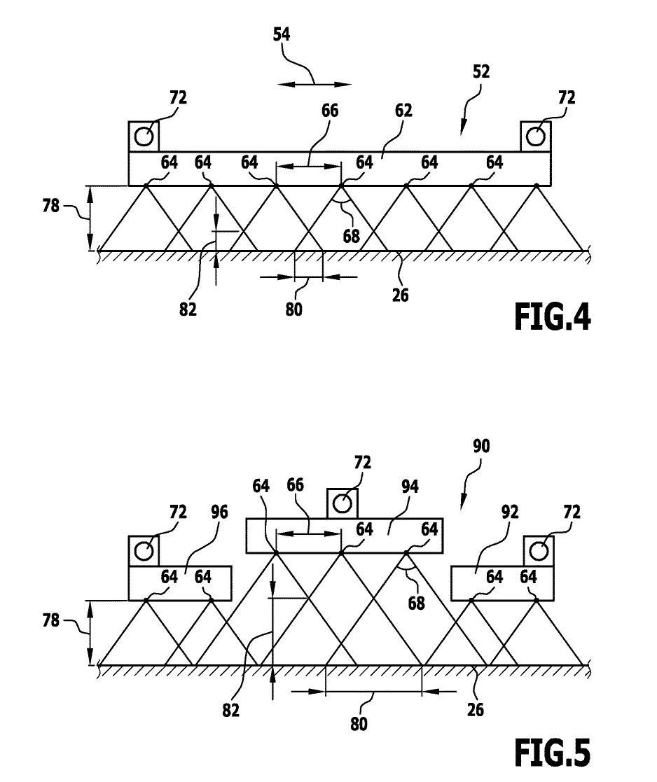

Held to the carrier 62 are a plurality of nozzles 64 of the drying apparatus 50. FIG. 4 schematically shows the carrier 62 and the arrangement of the nozzles 64 thereat.

In the vehicle wash facility 10 in accordance with the invention, the nozzles 64 are flat jet nozzles in particular. Each of the nozzles 64 can have exiting therefrom a flow of air that spreads out in a fan shape, widening in a direction towards the vehicle surface 26 that is to be dried.

The nozzles 64 are arranged in spaced relation to one another at the carrier 62. Preferably, the nozzles 64 are arranged in a straight line at the carrier 62 and laterally side-by-side in the transverse direction 54. The drying apparatus 50 comprises seven nozzles 64.

It is advantageous for the nozzles 64 to be arranged at the carrier 62 equidistantly. In an advantageous implementation of the vehicle wash facility 10, the distance 66 between adjacent nozzles 64 is, for example, approximately 15 cm to 25 cm, more preferably approximately 18 cm to 20 cm.

As mentioned, the nozzles 64 provide a flow of air that spreads out in a fan shape. In an advantageous implementation of the vehicle wash facility 10, the opening angle 68 of the air flow exiting at the nozzles 64 is approximately 50° to 80°, preferably approximately 70°.

Preferably, the nozzles 64 have an opening cross-section of approximately 140 mm² to 200 mm², measured as a projection along an outflow axis of the nozzles (in the drawing plane in FIG. 4).

The flat air flows exiting from the nozzles 64 lie in one plane or substantially in one plane. The plane can be pivoted by adjusting the nozzle support device 52 using the tilting device 58. It is possible, for example, for the plane to be oriented vertically (perpendicularly to the treatment direction 16). It is also conceivable that, by pivoting the nozzle support device 52, the plane is tilted such that the air flows of the nozzles 64 spread in a direction that has a component in the treatment direction 16 or opposite to the treatment direction 16. For example, this makes it possible for the air flows of the nozzles 64 to be oriented relative to the top side 24 such that the air flows always impact perpendicularly against the vehicle surface 26 to be dried.

The drying apparatus 50 comprises at least one blower 72 in order to supply the nozzles 64 with drying air. Here, two blowers 72 are provided for example. The blowers 72 are held to the carrier 62 for example. Drying air provided by the blowers 72 is supplied to the nozzles 64 and is provided by same in a fan shape in a direction towards the vehicle surface 26 in each case.

Preferably, the blowers 72 provide a volume flow of drying air of approximately 25 l/s to 35 l/s per nozzle 64.

The vehicle wash facility 10 comprises a control device 74 (FIG. 3). The control device 74 controls, for example, the movement of the wash gantry 12 and the function of the wash tools 44. The control device 74 is electrically connected to the lifting device 56 and the tilting device 58. The nozzle support device 52 can be raised or lowered or tilted about the tilting axis 60 depending on a signal of the control device 74.

It is also conceivable for the control device 74 to be electrically connected to the blowers 72 in order to adjust the amount of drying air that is provided to the nozzles 64.

The vehicle wash facility 10 further comprises a detection device 76. In particular, the detection device 76 allows the contour of the vehicle 18 to be detected and a corresponding signal to be provided to the control device 74. To this end, the detection device 76 comprises for example at least one light barrier or a light curtain with which the vehicle 18 is measured prior to the drying operation. Depending on the signal of the detection device 76, the control device 74 can determine the location of the top side 24, and hence of the vehicle surface 26 that is to be dried, relative to the position of the wash gantry 12 with respect to the vehicle 18. The location of the vehicle surface 26 relative to the nozzles 64 is thereby also known.

To dry the top side 24 using the roof drying apparatus 50, the following procedure can be used, for example:

The control device 74 moves the wash gantry 12 to an initial position in which the wash gantry 12 is arranged at the front side 20. The wash gantry 12 is then moved relative to the vehicle 18 along the treatment direction 16. The opposite operation may also be performed. The wash gantry 12 can be moved starting from the rear side 22 in a direction towards the front side 20 of the vehicle 18.

Depending on the previously detected signal of the detection device 76 and the vehicle contour determined therefrom, the control device 74 controls the lifting device 56 in such a manner that the nozzles 64 have a defined distance 78 relative to the top side 24 (FIG. 4).

In particular, the distance 78 is adjusted such that the air flows of adjacent nozzles 64 are adjacent to one another at the vehicle surface 26 or overlap at least partially at the vehicle surface 26. The latter instance is schematically illustrated in FIG. 4 in which the overlap of adjacent air flows at the vehicle surface 26 is approximately 5 cm to 10 cm. The reference numeral 80 designates a corresponding overlap region at the vehicle surface 26.

Air flows adjacent to one another intersect at a distance of approximately 5 cm from the vehicle surface 26. The corresponding distance is designated by the reference numeral 82 in FIG. 4.

When the wash gantry 12 is moved in the treatment direction 16, the lifting device 56 is raised or lowered via the control device 74 such that it is ensured that the air flows of nozzles 64 adjacent to one another, at the vehicle surface 26, are at least adjacent to one another or overlap one another. Preferably, the distance 78 of the nozzles 64 from the vehicle surface 26 is kept constant through control. The nozzle support device 52 is correspondingly raised or lowered via the lifting device 56 in order to follow the contour of the vehicle 18.

As mentioned, the plane of the air flows of the nozzles 64 can be vertical or can in each case be adjusted perpendicularly to the vehicle surface 26 by tilting the nozzle support device 52 via the tilting device 58. It is also conceivable to in each case provide a plane of the air flows of the nozzles 64 that is oriented obliquely to the treatment direction 16 in order to propel the liquid in the treatment direction 16 across the vehicle surface 26.

By the use of the flat jet nozzles 64 spaced at a distance from one another, the expenditure of energy to achieve a reliable drying result can be kept relatively low. The volume flow provided by the blowers 72 can be reduced when compared to that of drying apparatuses of conventional vehicle wash facilities.

By providing the air flows in one plane or in substantially one plane, liquid is reliably displaced from the vehicle surface 26. In order to prevent areas from being left undried on the vehicle surface 26 in transverse direction 54 between the nozzles 64, it is particularly advantageous for the air flows of adjacent nozzles 64, as described above, to be adjacent to one another or overlap one another at least in portions thereof at the vehicle surface 26.

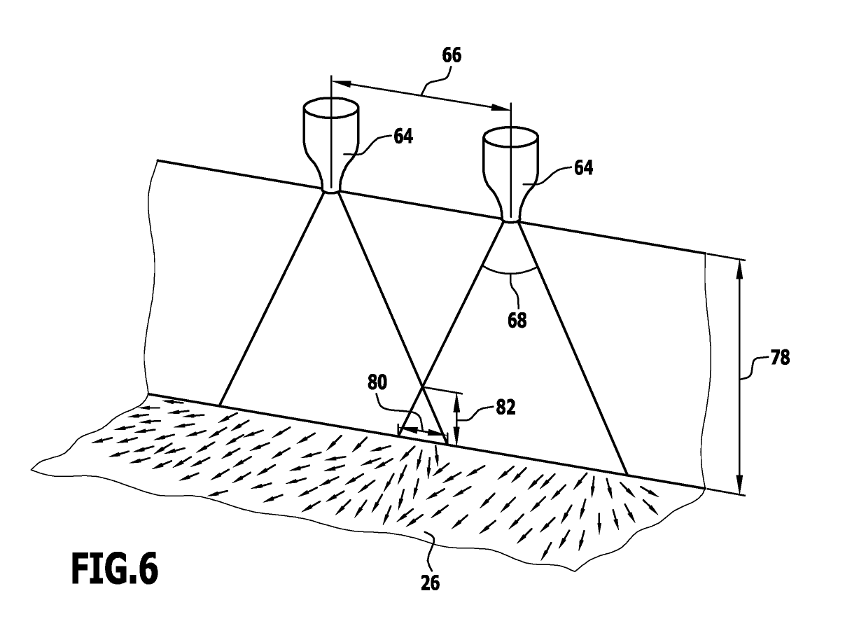

FIG. 6 schematically shows the overlap of the air flows of adjacent nozzles 64 at the vehicle surface 26 (only two nozzles 64 are illustrated). Also shown in FIG. 6 is how the air flows of adjacent nozzles already intersect above the vehicle surface 26. Arrows on the vehicle surface 26 symbolize local air flows.

It shows in practice that by use of the drying apparatus 50, the top side 24 can already be dried by only a single traverse of the wash gantry 12. During the return travel of the wash gantry 12 in a direction opposite to the treatment direction 16, the blowers 72 can be turned off, thereby giving an additional saving of energy. Furthermore, the wash gantry 12 can be moved more swiftly than with conventional vehicle wash facilities, thereby reducing total treatment time.

FIG. 5 schematically shows, in a manner corresponding to FIG. 4, a nozzle support device 52 of a drying apparatus as it may be used in a different vehicle wash facility in accordance with the invention, in place of the drying apparatus 50. The same reference numerals are used to denote identical or functionally equivalent features.

In the nozzle support device 90 depicted in FIG. 5, not only one carrier 62 is provided, but three carriers 92, 94, and 96 that are arranged side by side in a transverse direction. Each carrier 92, 94, 96 has at least one nozzle 64 arranged thereat. Here, the carriers 92 and 96 each have two nozzles 64 arranged thereat and the intermediate carrier 94 has three nozzles 64 arranged thereat.

For example, each carrier 92, 94, 96 has associated with it a blower 72 for supplying air to the nozzles 64 arranged at that carrier 92, 94, 96.

The carriers 92, 94, 96 are formed separately from one another and can be held to the wash gantry 12 together or separately from one another, in particular in a height-adjustable and/or tiltable manner, as is the case with the carrier 62. Each carrier 92, 94, 96 can have associated with it a separate lifting device 56 or tilting device 58. It is also conceivable for a common lifting device 56 or tilting device 58 to be employed.

In the variant form depicted in FIG. 5, the carrier 94 is arranged above the carriers 92, 96 in a height direction. It can thereby be ensured that larger overlap regions 80 between the air flows of nozzles 64 adjacent to one another at the vehicle surface 26 are achieved in the area of the vehicle's centre. This can have a beneficial effect on the drying result, for example.

Otherwise, the advantages that can be achieved in conjunction with the description of the drying apparatus 50 can also be achieved with use of the nozzle support device 90 so that in this respect reference can be made to the above statements.

### LIST OF REFERENCE NUMERALS

10 vehicle wash facility
12 wash gantry
14 support surface
16 treatment direction
18 vehicle
20 front side
22 rear side
24 top side
26 vehicle surface
28 hood
30 windscreen
32 roof
34 rear window
36 trunk lid
38 holding device
40 vertical support
42 transverse support
44 wash tool
46 side brush
48 roof brush
50 drying apparatus
52 nozzle support device
54 transverse direction
56 lifting device
58 tilting device
60 tilting axis
62 carrier
64 nozzles
66 distance
68 opening angle
72 blower
74 control device
76 detection device
78 distance
80 overlap region
82 distance
90 nozzle support device
92 carrier
94 carrier
96 carrier

1. A vehicle wash facility, comprising a drying apparatus for drying a motor vehicle which is held to a holding device of the vehicle wash facility and comprises a nozzle support device, at least one blower and a plurality of nozzles which are arranged at a distance relative to one another at the nozzle support device and which can be supplied with drying air by the at least one blower, wherein the nozzles are flat jet nozzles, each providing a flow of air that spreads out in a fan shape.

2. The vehicle wash facility in accordance with claim 1, wherein the drying apparatus is a roof drying apparatus of the vehicle wash facility.

3. The vehicle wash facility in accordance with claim 1, wherein the drying apparatus comprises a lifting device via which the nozzle support device is held to the holding device in a height-adjustable manner.

4. The vehicle wash facility in accordance with claim 3, wherein the vehicle wash facility comprises a detection device with which the location of a vehicle surface that is to be dried of the vehicle relative to the nozzles is detectable and wherein a distance of the nozzles from the vehicle surface is adjustable by way of the lifting device in such a manner that air flows of adjacent nozzles, at the vehicle surface, are adjacent to one another, or at least partially overlap one another.

5. The vehicle wash facility in accordance with claim 4, wherein the distance is adjustable such that the air flows of adjacent nozzles overlap one another above the vehicle surface to be dried.

6. The vehicle wash facility in accordance with claim 4, wherein the detection device allows the contour of the vehicle to be detected for determining the location of the vehicle surface to be dried.

7. The vehicle wash facility in accordance with claim 4, wherein the distance of the nozzles from the vehicle surface is less than approximately 50 cm.

8. The vehicle wash facility in accordance with claim 7, wherein the distance of the nozzles from the vehicle surface is approximately 10 cm to 25 cm.

9. The vehicle wash facility in accordance with claim 1, wherein an opening angle of the air flow provided by the nozzles is less than approximately 120°.

10. The vehicle wash facility in accordance with claim 9, wherein the opening angle of the air flow provided by the nozzles is approximately 50° to 80°.

11. The vehicle wash facility in accordance with claim 1, wherein a distance of adjacent nozzles relative to one another is approximately 10 cm to 30 cm.

12. The vehicle wash facility in accordance with claim 11, wherein the distance of adjacent nozzles relative to one another is approximately 15 cm to 25 cm.

13. The vehicle wash facility in accordance with claim 1, wherein the nozzles are arranged in equidistantly spaced relation to one another at the nozzle support device and are held to a carrier of the nozzle support device.

14. The vehicle wash facility in accordance with claim 1, wherein the nozzle support device comprises a carrier which is oriented transversely to a treatment direction of the vehicle wash facility and at which are arranged at least two nozzles side by side in a transverse direction, or wherein two or more carriers, arranged side by side in transverse direction, are provided, each of these having arranged thereat at least one nozzle.

15. The vehicle wash facility in accordance with claim 14, wherein the carrier is of straight-lined configuration and/or wherein the nozzles are arranged along a straight line at the carrier.

16. The vehicle wash facility in accordance with claim 14, wherein the carrier has a convex curvature in the treatment direction and/or wherein the nozzles are arranged at the carrier along an arc of convex curvature in the treatment direction.

17. The vehicle wash facility in accordance with claim 1, wherein the drying apparatus comprises a tilting device for tilting the nozzle support device about a tilting axis oriented transversely to the treatment direction.

18. The vehicle wash facility in accordance with claim 17, wherein the air flows of the nozzles are perpendicularly orientable towards a vehicle surface to be dried whose orientation is detectable by way of a detection device.

19. The vehicle wash facility in accordance with claim 1, wherein the air flows emitted from the nozzles are oriented transversely to the treatment direction.

20. The vehicle wash facility in accordance with claim 1, wherein the air flows emitted from the nozzles lie in one plane or substantially in one plane.

21. The vehicle wash facility in accordance with claim 1, wherein the nozzles are of identical configuration.

22. The vehicle wash facility in accordance with claim 1, wherein two or more nozzles are in flow communication with one blower of the at least one blower.

23. The vehicle wash facility in accordance with claim 1, wherein the drying apparatus comprises a plurality of blowers, each of which is associated with a nozzle.

24. The vehicle wash facility in accordance with claim 1, wherein the vehicle wash facility is or comprises a gantry-type wash facility.

25. The vehicle wash facility in accordance with claim 1, wherein the vehicle wash facility is or comprises a wash line.
